(19) United States
(12) Patent Application Publication
(10) Pub. No.: US 2004/0100990 A1
(43) Pub. Date: May 27, 2004

(54) On-demand bandwidth activation for detailed billing

(76) Inventors: Abraham Y. Chen, Mountain View, CA (US); David Ta-Wei Chen, Los Gatos, CA (US); Darru Kenneth Hsu, San Jose, CA (US)

Correspondence Address: ABRAHAM Y. CHEN - AVINTA COMMUNICATIONS, INC., 994 CHIPMAN DRIVE, MILPITAS, CA, 95035, US

(21) Appl. No.: 10/305,761

(22) Filed: Nov. 27, 2002

(51) Int. Cl. H04J 3/22

(52) U.S. Cl. 370/468; 370/352

(57) ABSTRACT

A method of requesting broadband content service with associated bandwidth provisioning in near real time is disclosed. With this concise facility, broadband services may be deployed in the conventional “always-on” mode but at a bare minimum bandwidth. This will encourage much larger subscriber base than currently possible. The convenience of obtaining premium service on-demand offers content providers and carriers opportunity to realize profits based on subscriber's improved willingness.

The ability to associate a bandwidth request to a specific consuming node disclosed in this invention not only allows service providers to issue detailed billing statements that minimizes potential disputes, but also enables the ability to curb non-subscriber access or unauthorized use of bandwidth by certain subscribers taking advantage of the always-on broad bandwidth.

### BACKGROUND OF THE INVENTION

1. Technical Field

This invention pertains to a near real time broadband bandwidth and content service provisioning method that directly interacts with subscribers and billing system.

2. Description of the Related Art

The advent of digital broadband transmission technologies has enabled Internet to reach the mass public with significant information delivery capabilities. At the beginning, this capability was just a potential promised by marketers. Being limited by its actual capacity and also attempting to encourage subscribers, broadband services to consumers have been offered in “always-on” mode, regardless whether a connection is in actual use or not. For operational convenience, the maximum available data rate or, bandwidth is “provisioned” when a subscriber signs on to the service. It is a best-effort “pipe” that service provider sets up backbone connection to the Internet. To maintain adequate subscribers satisfaction, this has been dealt with by applying usage statistics to a large group of subscribers and by augmenting the backbone capacity. Although there are tiered pricing based on different maximum data rates among broadband services, they have been largely applied to business subscribers on pre-scheduled, timed basis. Consumers normally subscribe to fixed (max) bandwidths. The overall operation cost of such a system is evenly divided among the subscribers according to bandwidth subscribed, with little sensitivity to the actual usage.

As time goes on, the broadband capability has exceeded the need of ordinary subscribers. Service providers could no longer offer differentiable quality of bandwidth tiers. Consequently, the above principle has become an impediment to the deployment of broadband services to the mass public. A few factors have become apparent:

A. There is no clearly proven business model to justify newer and more capable technologies for mass deployment.

B. WAN connection providers cannot ascertain their return on capital investment by providing more backbone capacity for offering tiered bandwidth services at acceptable quality.

C. It is well understood that consumers are mostly content with the bare minimum that they perceive is necessary. Only a small percentage of earlier adopters would jump onto a bandwagon just because it is newer and better. On the other hand, full infrastructure deployment must be ready in order to anticipate and serve the demand.

D. Furthermore, few consumers would consciously pay more for unsubstantiated benefits.

Therefore a fresh approach to providing WAN broadband services is needed, as any capital investment to improve or add tiered services to “always-on” connections will not assure additional revenue opportunities. A tie-in to content service providers would further strengthen the ubiquity and nearly lowest cost of billing per transaction of WAN connection providers.

### SUMMARY OF THE INVENTION

Thus, it is the purpose of this invention to disclose a system that encourages the deployment of basic broadband connection that is priced at “cost plus minimum return” basis, while the advanced services are optional and charged at “cost plus profit” rates.

It is also the goal of this invention to present a very simple and low cost deployment of user interface so that the process to consume broadband services is the least burdensome to a user (cost per broadband service transaction). This would encourage a larger set of population to adopt broadband on-demand bandwidth services while providing additional revenue opportunities for both WAN connection and content service providers.

Another object of this invention is to provide fully controllable and manageable method of bandwidth provisioning for both always-on and on-demand subscriber services. This invention offers an alternative to additional equipments or technologies that are normally required, but not in the possession of, or controlled by, service providers. That scenario of provisioning service without the ability to control the means of delivering service is subjected to abuse where non-subscribers can easily establish wireless or wired Local Area Networks (LAN) for unreported shared accesses.

Yet another object of this invention is to provide a commonly acceptable method to identify and/or bill bandwidth consumption to an addressable “subnet” node on LAN data network comparable to an “Extension” telephone on PBX (Private Branch eXchange) system.

The features of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1 is the overall system arrangement of this invention.

FIG. 2 is an example showing a content list of applications for the consumer to select from.

FIG. 3 is a flowchart example of consumer interface with the system.

FIG. 4 is an example of available bandwidth choices together with corresponding charge rates to be chosen according to the need of an application.

### DESCRIPTION OF THE PREFERRED EMBODIMENT

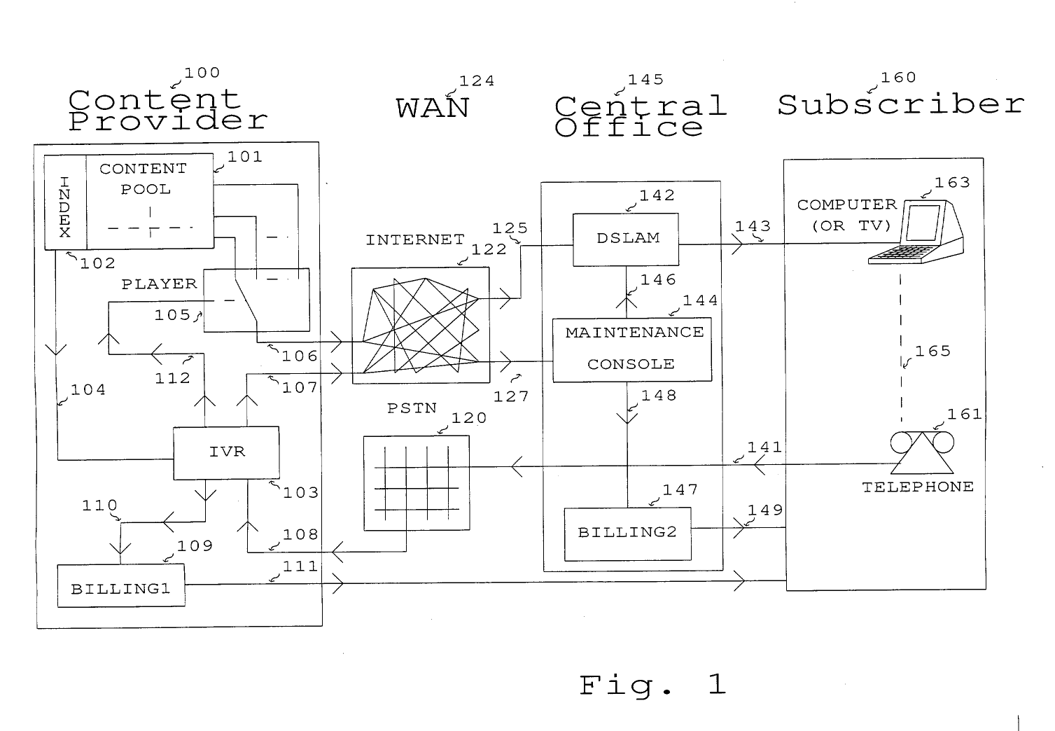

FIG. 1 depicts the interconnections among various subsystems of the current invention. Content Provider 100 has a broadband Content Pool 101. The Index 102 of such Content Pool 101 is provided to IVR (Interactive Voice Response) 103 through data link 104. IVR 103 is connected to PSTN (Public Switched Telephone Network) 120 through telephone line 108. A telephone set 161 belonging to Subscriber 160 is connected to PSTN 120 via telephone line 141.

The Content Provider 100 also has a content Player 105 that can selectively send certain portion of the information in Content Pool 101 to Internet 122 via data link 106. Note that Internet 122 and PSTN 120 are well-known public data and voice communication networks, respectively. Together, they are often referred to as WAN (Wide Area Network) 124. Thus, they are not detailed here. After passing through Internet 122, the broadband content service information follows data link 125 to DSLAM (DSL Access Multiplex) 142 located inside of a local telephone company's Central Office 145, then delivered to a Computer (or TV or other broadband equipment) 163 inside the premise of Subscriber 160 via data link 143. The Central Office 145 provides, among other functions, the broadband connection provisioning service to Subscriber 160.

The operational characteristics of DSLAM 142, such as bandwidth, are controlled by Maintenance Console 144 through data link 146. Inputs to Maintenance Console 144 are normally via manual operation or through non-real time interfaces with OSS (Operation & Support Systems) commonly used in the telephony industry. Thus, they are not detailed here.

To facilitate the operational description of the current invention, data links 107 and 127 are added such that IVR 103 can send provisioning requests to Maintenance Console 144 via Internet 122 in response to provisioning requests. The provisioning requests are initiated by the Telephone 161 within Subscriber 160.

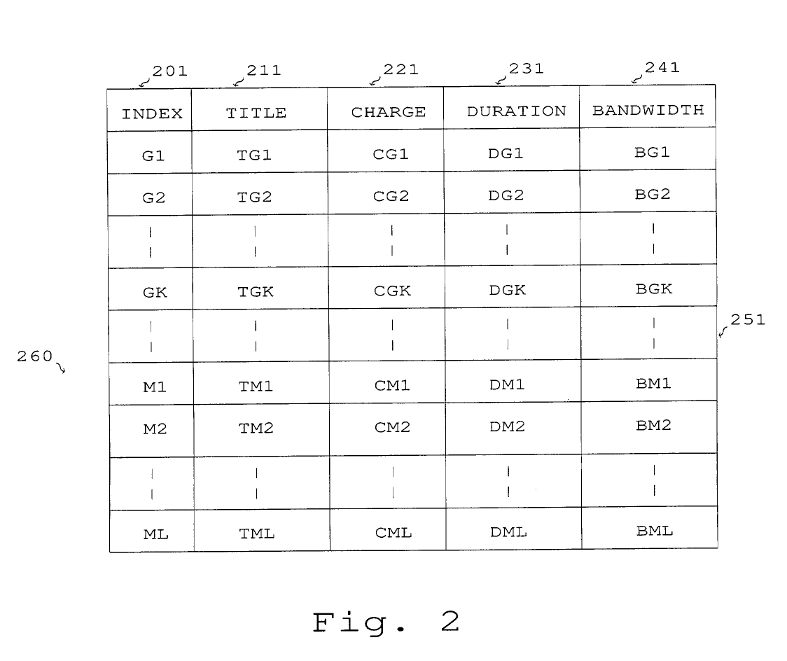

FIG. 2 is a table, as an example, presenting the key descriptions of the information in Content Pool 101. The data in Index column 201 will be made available to Subscriber 160 to select one of the services. By way of example, G1, G2, . . . GK represent choice of interactive Games, and M1, M2, . . . ML represent Movies. Row 251 represents other categories of contents such as sports club activities that may need broadband delivery. The information in Title 211 (TG1, TG2 - - - TGK, and TM1, TM2, . . . TML), Charge 221 (CG1, CG2, . . . CGK, and CM1, CM2, . . . CML), Duration 231 (DG1, DG2, . . . DGK, and DM1, DM2, DML) and Bandwidth 241 (BG1, BG2, . . . BGK, and BM1, BM2, . . . BML) will be utilized by IVR 103 in the audio announcements during a call from Subscriber 160 for selecting applications.

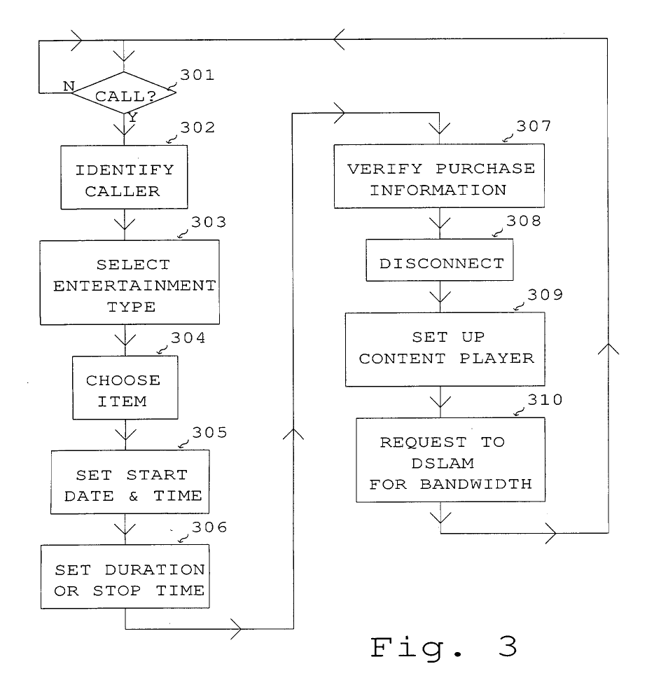

FIG. 3 outlines a typical session between IVR 103 and Subscriber 160 during the selection of a broadband service. Normally, a caller utilizes DTMF (Dual Tone Multi-Frequency) keypad on the telephone to send commands to an IVR device that responds in synthesized voice with appropriate information. The general techniques of this type of interaction are commonly known and have been used in many applications. Therefore, it is not detailed here. The following is an outline of the process that will facilitate the understanding of the specifics of the current invention.

IVR 103 is normally in a standby mode (box 301), waiting for calls. When a call is received, the caller (Subscriber 160) is identified (box 302). Since PSTN 120 routinely provides Caller-ID service based on ANI (Automatic Number Identification) information, this can be normally performed without the caller's active involvement. IVR 103 proceeds to, basing on the Content List 260, interact with the subscriber 160 for selecting the type of entertainment (box 303), e.g., Game or Movie, and then choose a specific Item (box 304), e.g., Movie M2. Next, Subscriber 160 specifies the date and time for the service to commence (box 305). Lastly, Subscriber 160 may specify the duration of the service (box 306).

Then, IVR 103 recites the purchase details for Subscriber 160 to confirm (box 307), before disconnect (box 308). Afterwards, IVR 103 sends necessary parameters to the content Player 105 via data link 112 to deliver the service requested at specified time (box 309). In addition, IVR 103 makes a bandwidth request to Maintenance Console 144 via data link 107, Internet 122 and data link 127 (box 310) before returning to the standby mode (box 301).

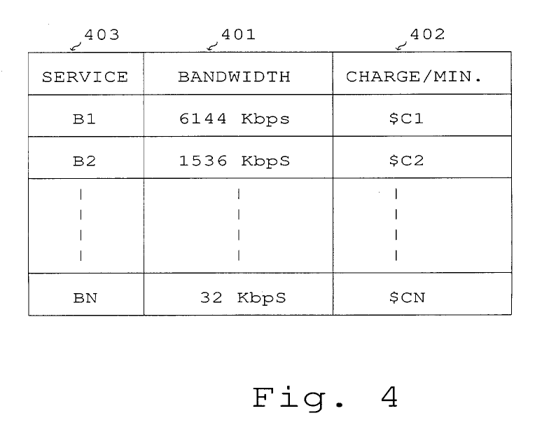

FIG. 4 presents a list of possible Bandwidth 401 for xDSL (including varieties of DSL types, e.g. ADSL, VDSL, etc.) services and corresponding Charge/Min. rates 402. Service 403 is used to represent each pair as an index. The actual values of these are not important for the scope of this invention, as Central Office 145 may supply its own set of possible bandwidths of each DSLAM 142 for Content Provider 100 to choose from.

With FIG. 4, the actual values in Bandwidth 241 will be assigned with the appropriate entries under Service 403. This allows each application in FIG. 2 to be associated with a specific bandwidth for actual delivery. For example, for Movie M2 under Index 201, the desired Bandwidth 241, BM2 may be specified as B1 under Service 403 which specifies the actual Bandwidth 401 to be 6144 Kbps with a Charge/Min. 402 equal to $C1.

Upon completing the service delivery as requested, IVR 103 sends charge information (M2, TM2, CM2, BM2) to a billing subsystem, Billing1 109 via data link 110, so that detail billing of the content service can be sent to Subscriber 160 via path 111. In addition, Maintenance Console 144 sends charge information about the bandwidth service provided by DSLAM 142 (B1, 6144 Kbps, $C1) to billing subsystem Billing2 147 via data link 148, so that detail billing of the bandwidth connection service can be sent to Subscriber 160 via path 149.

The actual implementation of the above billing subsystems, Billing1 109, Billing2 147 and path 111, path 149 can be integrated into the standard telephone monthly billing to Subscriber 160 according to established data transfer format. This kind of itemized billing, comparable to alternate long distance carrier or information access services, is part of standard PSTN operational practices. Therefore, it is not detailed here.

Note that connections between Subscriber 160 and Central Office 145 are shown as two connections, traditional telephony through line 141 and xDSL through line 143. In reality, they are carried in separate frequency bands over the same pair of copper wires. They are purposely shown as separated lines in FIG. 1 to clarify the presentation. This also offers the understanding that the current invention may also be applied to other broadband delivery systems such as coaxial Cable, optical Fiber and Radio Frequency including Satellite transmissions by replacing subsystems 142 and 143 with those of the specific corresponding technology that may or may not share with line 141.

Also, POTS (Plain Old Telephone Service) is used in the figures to signify that this process may be accomplished simply through using the traditional telephony equipments. More sophisticated access method such as personal computer's keyboard and monitor interactions through Internet connection falls within the scope of the current invention.

Note that in the case of using personal computer or the like to request bandwidth via Internet 122, the IVR 103 would be replaced with a web server providing interactions of equivalent functionality.

For simplicity in basic presentation, Computer 163 and Telephone 161 in FIG. 1 were described as independent and single data and voice communication equipment, respectively. In many premises, there are multiple telephone instruments on the same telephone line 141. Similarly, there are multiple data equipments sharing the same broadband connection 143. To establish a homogeneous operation, devices in different rooms need be networked as well as voice and data communication should be coordinated. The first part has been accomplished by U.S. Pat. Nos. 5,596,631 & 5,696,790, entitled “Station controller for distributed single line PABX” & “Method and apparatus for time dependent data transmission”, respectively. The second part has been achieved by a pending application Ser. No. 09/522,425, entitled “User Settable Unified Workstation Identification System” whose inventor is among the inventors of this current invention. To represent the close correlation between the operations of Computer 163 and Telephone 161, a dashed line 165 has been placed in FIG. 1.

With the technologies outlined above, the current invention of bandwidth-on-demand services can be correlated to a specific workstation identified by the corresponding extension number of the telephone set. Therefore, the billing process disclosed above can be further detailed to a specific extension number within Subscriber 160, from which the enhanced broadband service is requested and received. This capability would be very useful for services to single-family with multiple members, shared apartment, MTU (Multi-Tenant Unit) and SOHO (Small Office Home Office), etc.

Although the broadband content flow in the above disclosed example is from the content provider toward the subscriber, similar on-demand bandwidth could be set up for the purpose that a subscriber wishes to send bulk information towards content provider. For example, the subscriber may be one of the creators of the movies, games, etc. that the content provider will be offering to other subscribers. Along this line of application, the subscriber could be sending other forms of bulk electronic information such as Email with large attachments. Having the capability of requesting for a broader bandwidth would shorten the time required to send such package out from the subscriber.

A further application of this capability is to allow connection providers to effectively utilize the bandwidth available. In fact, making bandwidth beyond the basic connection grade of service available only upon request and agreement will curb the abuse that is becoming a concern.

As another example, the provisioning of bandwidth service through line 143 to Computer 163, can be identified and authenticated for the intended individual consuming party within Subscriber 160. Any unauthenticated use of bandwidth by a specific “extension” can, therefore, be denied of bandwidth service delivery. The entire procedure can be carried out totally within the internal parts of Central Office 145, such as Billing subsystems 147, Maintenance Console 144 and DSLAM 142 regardless of the physical transport of networking over line 143 (e.g. Phone line, RF, Power line, etc.).

As yet another example, The DTMF singling as provided with Telephone 161 can be electronically automated and program controlled so that Subscriber 160 can request and receive variety of bandwidth related services (e.g. Internet gaming, fee based reception of Internet programming, security intrusion alert & monitoring, application specific needs, etc.) for devices connected over line 143.

This invention has been described with particular attention to its preferred embodiment. It should be understood that variations and modifications within the spirit and scope of the invention may occur to those skilled in the art to which the invention pertains.

I claim:

1. A method of requesting near real time broadband content service and bandwidth provisioning initiated by subscriber, yet under full control by content and connection providers comprising the steps of;
said subscriber communicates via a Wide Area Network (WAN) means to said content provider to request said broadband content service;
said content provider receives said request utilizing interactive communications equipment appropriate to interact with said WAN means being used by said subscriber;
said content provider executes said content service request by first making a request to said connection provider to activate said bandwidth required prior to commencing delivery of said content service.

2. A system of requesting near real time bandwidth as recited in claim 1, facilitates said broadband connection service to be offered at bare minimum bandwidth for “alwayson” connection.

3. A system of requesting near real time bandwidth as recited in claim 1, comprising interface means to conventional billing equipment in Public Switched Telephone Network (PSTN) for minimum cost in processing service charges.

4. A method of requesting near real time broadband content service and bandwidth provisioning initiated by subscriber, yet under full control by content and connection providers comprising the steps of;
said subscriber communicates via a Wide Area Network (WAN) means to said content provider to request submission of content;
said content provider receives said request utilizing interactive communications equipment appropriate to interact with said WAN means being used by said subscriber;
said content provider executes said content submission request by first making a request to said connection provider to activate said bandwidth required prior to commencing receipt of said content.

5. A system of delivering broadband content service as recited in claims 1 and 4, comprising means to associate identity of said request with that of a device consuming said content service, enabling said billing system to issue detailed billing statement associating said device to said service.

6. A system as recited in claim 5, enables said connection provider to utilize available bandwidth to its fullest extend for intended said subscribers, effectively stopping bandwidth abuse by unauthorized accesses.
